(19) United States
(12) Patent Application Publication
(10) Pub. No.: US 2006/0106682 A1
(43) Pub. Date: May 18, 2006

(54) Web based configuration tool

(76) Inventors: Jeffery J. Van Dyck, Edmonds, WA (US); Mark N. Larson, Mukilteo, WA (US)

Correspondence Address: KLEIN, O'NEILL & SINGH, 2 PARK PLAZA, SUITE 510, IRVINE, CA, 92614, US

(21) Appl. No.: 10/986,703

(22) Filed: Nov. 12, 2004

(51) Int. Cl. G07F 7/00; G06F 17/30

(52) U.S. Cl. 705/27; 705/26

(57) ABSTRACT

A method and system for product configuration is provided. The system includes, a user interface that allows a user to configure a product; a web-based application that interfaces with the user interface, a data collector module and a view creation module allowing a user to configure the product; and a data communication layer that interfaces between the web-based application and plural databases for building an XML based product configuration database. XML tags are used for identifying various options that are selected by the user. The method includes, creating and/or updating catalog data using XML tags; allowing a user to select product configuration options; and displaying user selected product options. The user interface includes a configuration interface; catalog interface; viewing interface and a summary interface. The configuration interface allows a user to build an overall product configuration; and the catalog interface allows a user to select and/or de-select plural options.

### CROSS REFERENCE TO RELATED APPLICATION

None

### BACKGROUND OF THE INVENTION

1. Field of the Invention

This invention relates generally to computerized design tools, and more particularly, to a web based configuration design tool that uses XML tags to identify objects.

2. Description of Related Art

Computer aided design tools are commonly used to design and illustrate various products and assemblies, for example, aircraft, automobiles, trains, ships, houses and other assemblies. The aerospace industry has used various software programs to illustrate aircraft design, as two dimensional (“2D”) and three dimensional (“3D”) illustrations. Examples of such software include, CATIA®, Unigraphics® and AutoCAD®.

Different airlines need different features in an aircraft. Generally, aircraft manufacturers provide a catalog (list) of features to an airline. The catalog lists various options that are available in an aircraft. The airline is allowed to generate an initial overall Layout of Passenger Accommodations (“LOPA”), which is the interior layout of the aircraft. The airlines select options/features from a catalog, after selecting a preliminary LOPA. The selected options and a finalized LOPA is then communicated inefficiently to various departments that are responsible for engineering, manufacturing and publication of supporting documentation of the configured aircraft. The configuration is communicated in different formats.

The overall system involves various steps and manual operations. The configuration process is tedious and inefficient. Also, the lead-time to accommodate user changes is long and there are delays in communicating information to the user (or customer, used interchangeably throughout this specification).

Although the foregoing problem is highlighted with respect to the aerospace industry, the same problems arise in other areas, for example, building trains, trucks, automobiles and others.

Therefore, there is a need for an automated, platform independent configuration tool that efficiently generates product configuration.

### SUMMARY OF THE INVENTION

In one aspect of the present invention, a graphical user interface (“GUI”) for product configuration is provided. The GUI includes a configuration interface that allows a user to build an overall product configuration; a catalog interface that allows a user to select and/or de-select plural options; a viewing interface that allows a user to view the overall product configuration and the plural options selected using the catalog interface; and a summary interface that provides a summary of the plural options that are selected by the user.

The catalog interface shows the change in product weight and cost when a user selects and/or de-selects an option. The viewing interface allows a user to view the product configuration with a selected option or a de-selected option.

It is noteworthy that the GUI may be used to configure plural products including an aircraft.

In another aspect of the present invention, a system for product configuration is provided. The system includes, a user interface that allows a user to configure a product; a web-based application that interfaces with the user interface, a data collector module and a view creation module allowing a user to configure the product; and a data communication layer that interfaces between the web-based application and plural databases for building an XML based product configuration database.

An options database is used to provide catalog data to a user for selecting and/or de-selecting options using the user interface. The data collector module interfaces with a configuration repository that stores a user selected configuration and is made available to plural business units. XML tags are used for identifying various options that are selected by the user.

In yet another aspect of the present invention, a method for product configuration is provided. The method includes, creating and/or updating catalog data using XML tags; allowing a user to select product configuration options; and displaying user selected product options.

This brief summary has been provided so that the nature of the invention may be understood quickly. A more complete understanding of the invention can be obtained by reference to the following detailed description of the preferred embodiments thereof, in connection with the attached drawings.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, wherein:

FIG. 1A shows a block diagram of a computing system for executing process steps, according to one aspect of the present invention;

FIG. 1B shows the internal architecture of the computing system in FIG. 1A;

FIG. 2A is a block diagram of the overall architecture of a configuration tool, according to one aspect of the present invention;

FIG. 2B shows the use of XML tagging as used in the architecture of FIG. 2A;

FIG. 3 shows a process flow diagram for using the configuration tool, according to one aspect of the present invention; and

FIGS. 4A-4D show screen shots of a user interface, according to one aspect of the present invention.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein, specifically to provide for a method and system for generating product configuration.

In one aspect of the present invention, a configuration tool is provided. The description below is described with respect to an aircraft interior, but may be used for other products/assemblies. The configuration tool includes a web-based user interface with plural views. The user interface allows a user to create a LOPA, automatically select various options from a catalog view, and use a 3D module to view the options. A summary of the various options and the selected configuration may be viewed and communicated to various business units (or departments/organizations) that are involved in building the aircraft.

In one aspect of the present invention, the configuration tool uses tagged XML, tagged Scalable Vector Graphics (“SVG”) and Extensible Markup Language (“XML”) tagged 3D objects. XML is a standard mark-up language as published by W3C Consortium and is incorporated herein by reference in its entirety. XML allows programmers to create their own customized tags, enabling definition, transmission, validation, and interpretation of data between applications and between organizations. XML tags are used to store documents as text files.

Configuration data using the XML standards may be shared across plural platforms. XML templates (for example, extensible style sheets “XSLTs”) may be used to publish data using the Internet, as a “PDF” document, and with hand-held devices (for example, personal digital assistants). Extensible Style Language Transformation is the language used in XSLT style sheets to transform XML documents.

To facilitate an understanding of the preferred embodiments of the invention, the general architecture and operation of a computing system will be described. The specific architecture and operation of the preferred embodiments will then be described with reference to the general architecture.

Computing System:

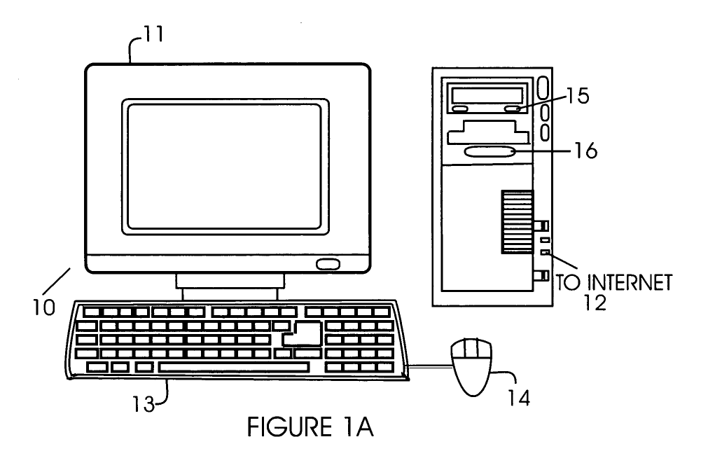

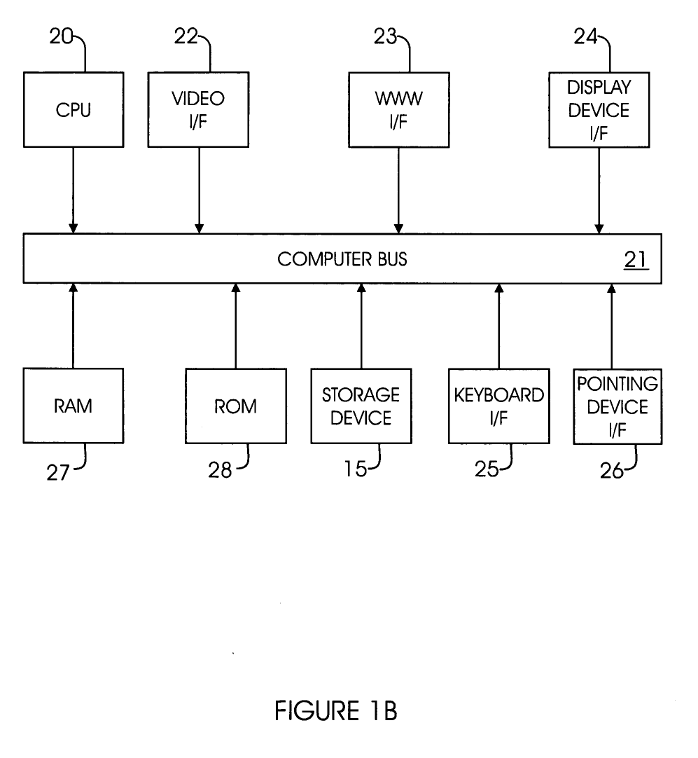

FIG. 1A is a block diagram of a computing system for executing computer executable process steps according to one aspect of the present invention. FIG. 1A includes a host computer 10 and a monitor 11. Monitor 11 may be a CRT type, a LCD type, or any other type of color or monochrome display (or any other display device including a high definition television station).

Also provided with computer 10 are a keyboard 13 for entering data and user commands, and a pointing device (for example, a mouse) 14 for processing objects displayed on monitor 11.

Computer 10 includes a computer-readable memory storage device 15 for storing readable data. Besides other programs, storage device 15 can store application programs including web browsers by which computer 10 connect to the Internet (or any other network), and the computer-executable code according to the present invention.

According to one aspect of the present invention, computer 10 can also access computer-readable floppy disks(or any other media) storing data files, application program files, and computer executable process steps embodying the present invention or the like via a floppy disk drive 16. A CD-ROM, or CD R/W (read/write) interface (not shown) may also be provided with computer 10 to access application program files, and data files stored on a CD-ROM.

A modem, an integrated services digital network (ISDN) connection, or the like also provide computer 10 with an Internet connection 12 to the World Wide Web (WWW). The Internet connection 12 allows computer 10 to download data files, application program files and computer-executable process steps embodying the present invention.

It is noteworthy that the present invention is not limited to the FIG. 1A architecture. For example, notebook or laptop computers, set-top boxes or any other system capable of running computer-executable process steps, as described below, may be used to implement the various aspects of the present invention.

FIG. 1B is a block diagram showing the internal functional architecture of computer 10. As shown in FIG. 1B, computer 10 includes a central processing unit (“CPU”) 20 for executing computer-executable process steps and interfaces with a computer bus 21. Also shown in FIG. 1B are a video interface 22, a WWW interface 23, a display device interface 24, a keyboard interface 25, a pointing device interface 26, and storage device 15.

Storage device 15 stores operating system program files, application program files, web browsers, and other files. Some of these files are stored using an installation program. For example, CPU 20 executes computer-executable process steps of an installation program so that CPU 20 can properly execute the application program.

Random access memory (“RAM”) 27 also interfaces to computer bus 21 to provide CPU 20 with access to memory storage. When executing stored computer-executable process steps from storage device 15 (or other storage media such as floppy disk 16 or WWW connection 12), CPU 20 stores and executes the process steps out of RAM 27.

Read only memory (“ROM”) 28 is provided to store invariant instruction sequences such as start-up instruction sequences or basic input/output operating system (BIOS) sequences for operation of keyboard 13.

Computer-executable process steps, according to one aspect of the present invention may be performed using the Internet. A web-based interface, according to one aspect of the present invention allows a user to transmit configuration information to plural users. The following provides a brief description of the Internet.

The Internet connects plural computers world wide through well-known protocols, for example, Transmission Control Protocol (TCP)/Internet Protocol (IP), into a vast network. Information on the Internet is stored world wide as computer files, mostly written in the Hypertext Mark Up Language (“HTML”). Other mark up languages may also be used. The collection of all such publicly available computer files is known as the World Wide Web (WWW). The WWW is a multimedia-enabled hypertext system used for navigating the Internet and is made up of hundreds of thousands of web pages with images and text and video files, which can be displayed on a computer monitor. Each web page can have connections to other pages, which may be located on any computer connected to the Internet.

A typical Internet user uses a client program called a “Web Browser” to connect to the Internet. A user can connect to the Internet via a proprietary network, such as America Online or CompuServe, or via an Internet Service Provider, e.g., Earthlink. The web browser may run on any computer connected to the Internet. Currently, various browsers are available of which two prominent browsers are Netscape Navigator and Microsoft Internet Explorer.

The Web Browser receives and sends requests to a web server and acquires information from the WWW. A web server is a program that, upon receipt of a request, sends the requested data to the requesting user.

A standard naming convention known as Uniform Resource Locator (“URL”) has been adopted to represent hypermedia links and links to network services. Most files or services can be represented with a URL. URLs also enable two programs on two separate computers to communicate with each other through simple object access protocol (“SOAP”), XML and other protocols published by the W3C consortium, incorporated herein by reference in their entirety.

URLs enable Web Browsers to go directly to any file held on any WWW server. Information from the WWW is accessed using well-known protocols, including the Hypertext Transport Protocol (“HTTP”), the Wide Area Information Service (“WAIS”) and the File Transport Protocol (“FTP”), over TCP/IP protocol. The transfer format for standard WWW pages is HTTP. It is noteworthy that the invention is not limited to standard WWW or W3C protocols for server access and information exchange.

System Architecture

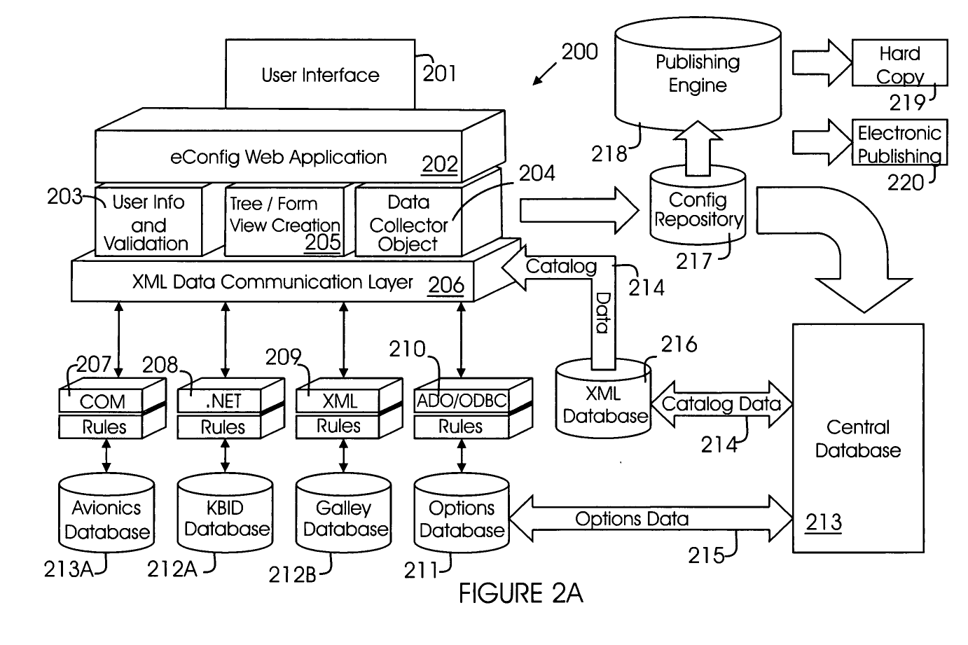

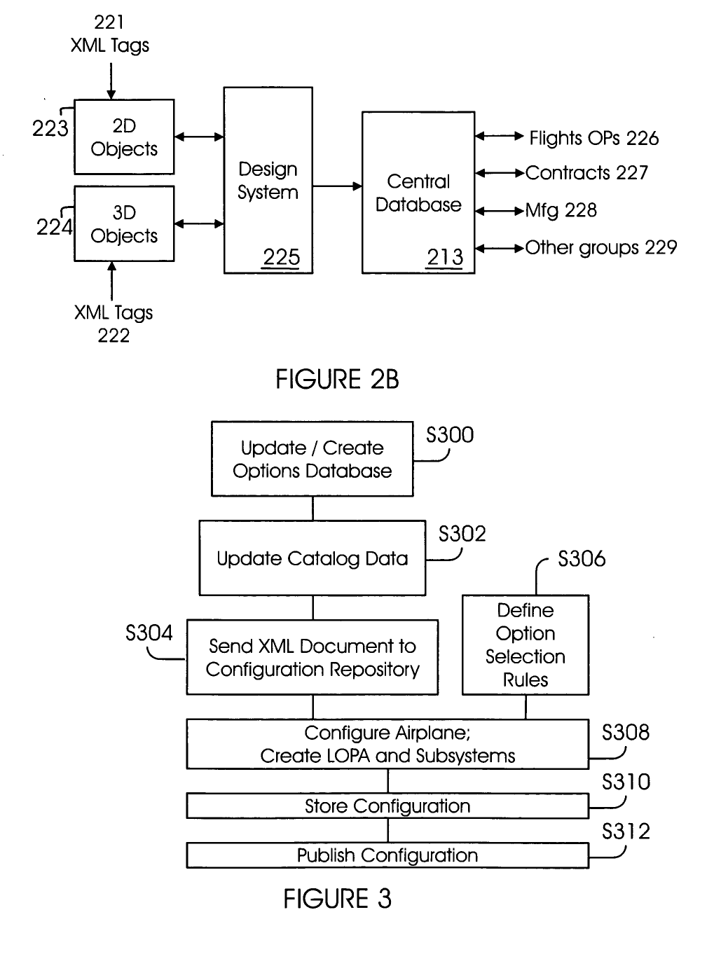

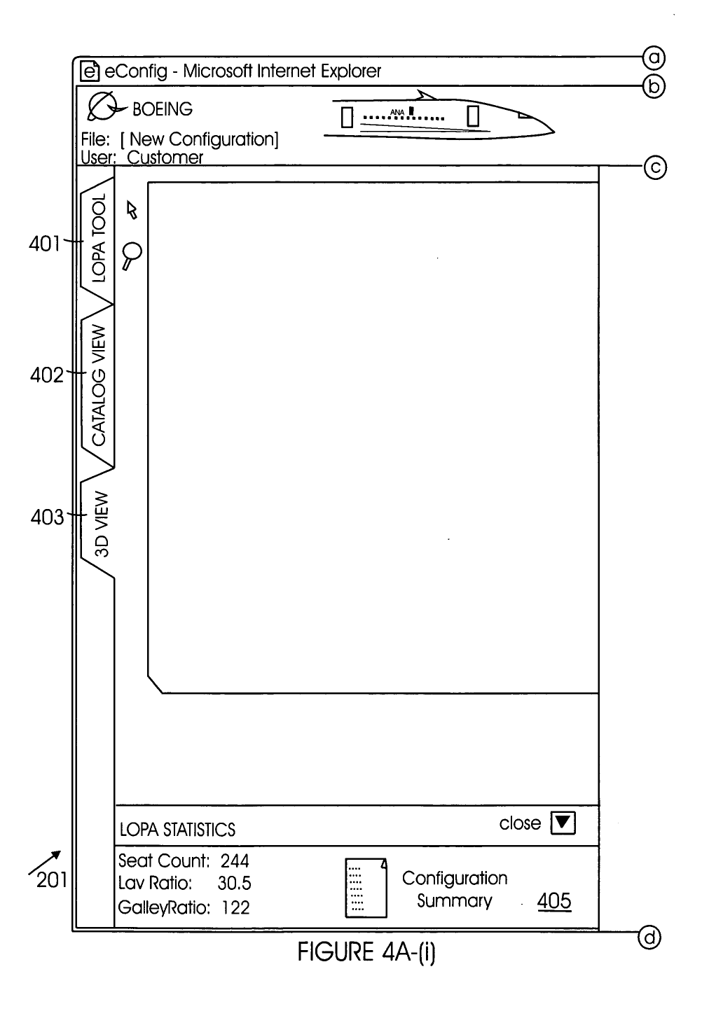

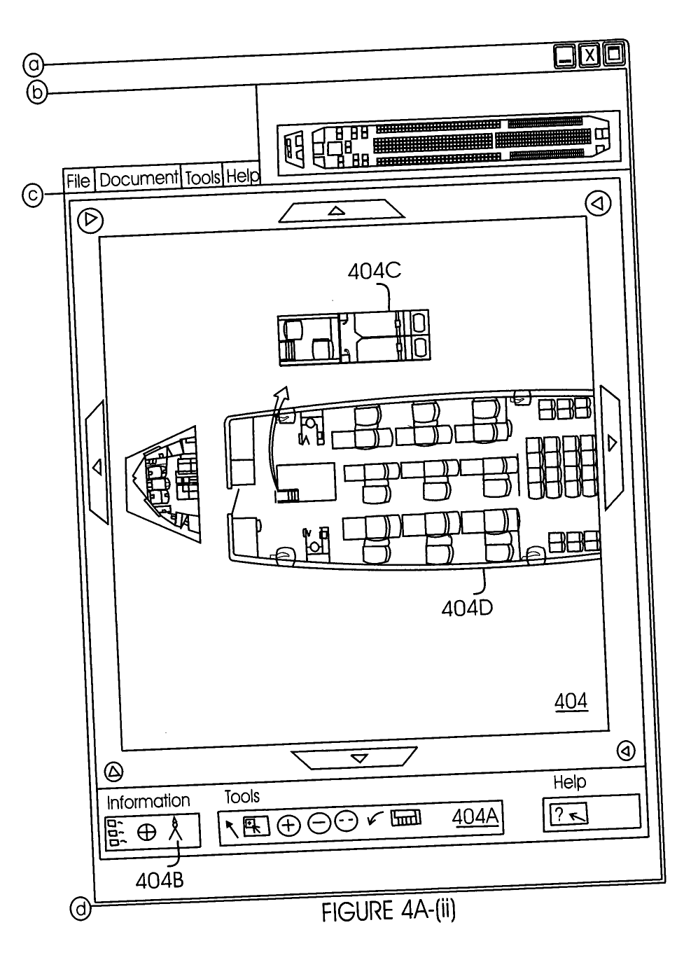

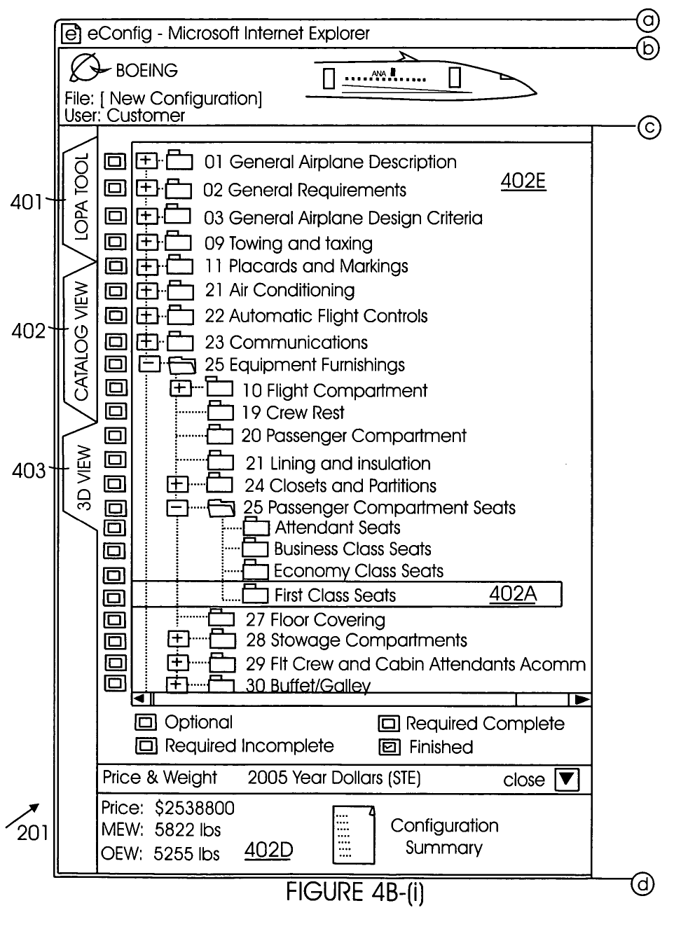

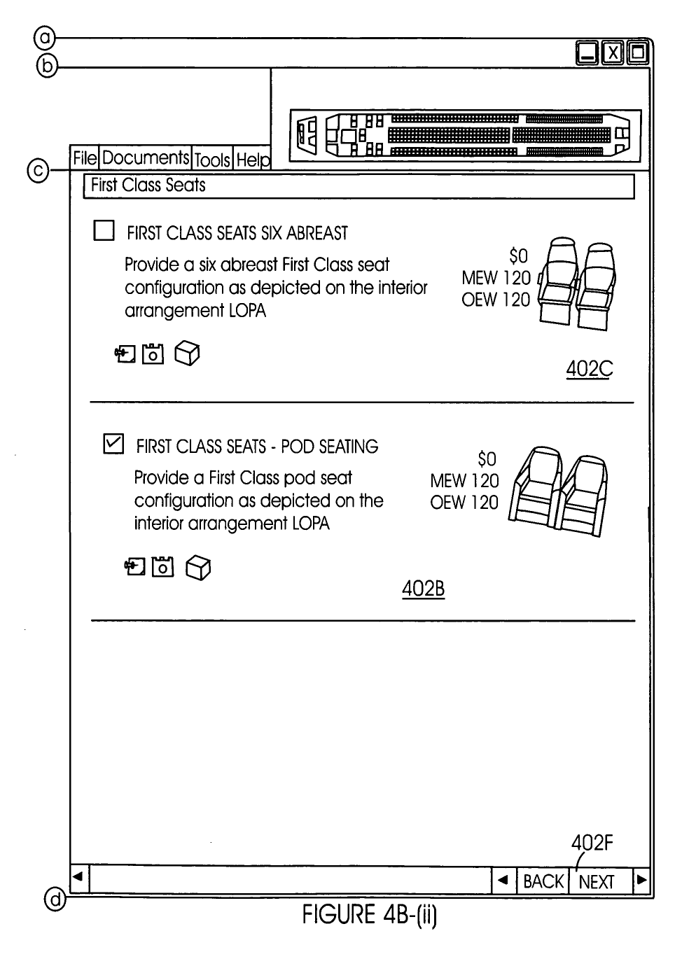

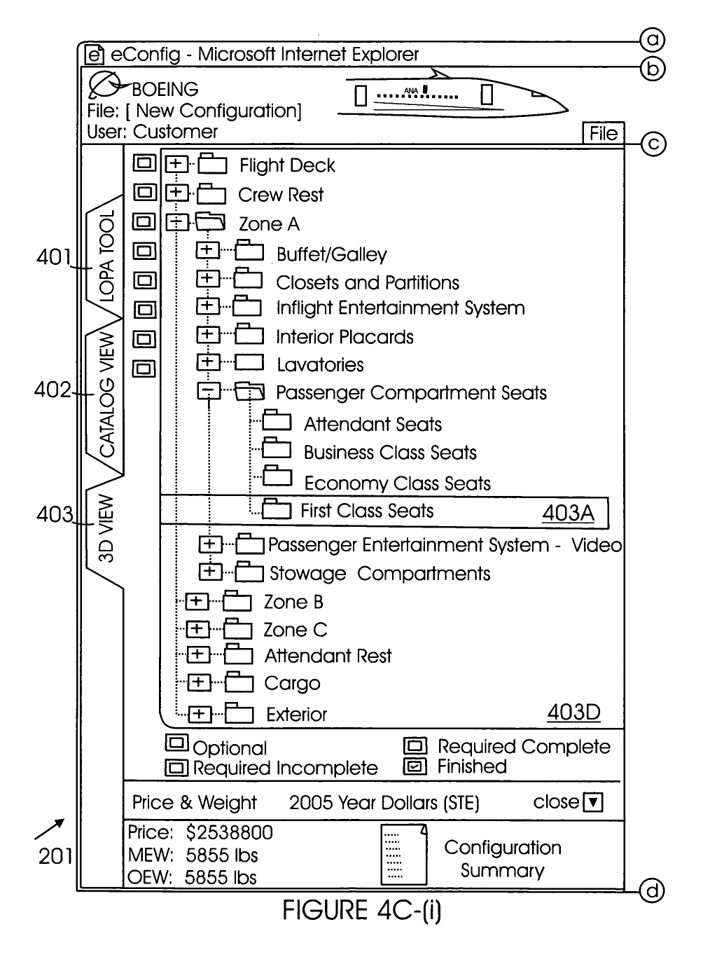

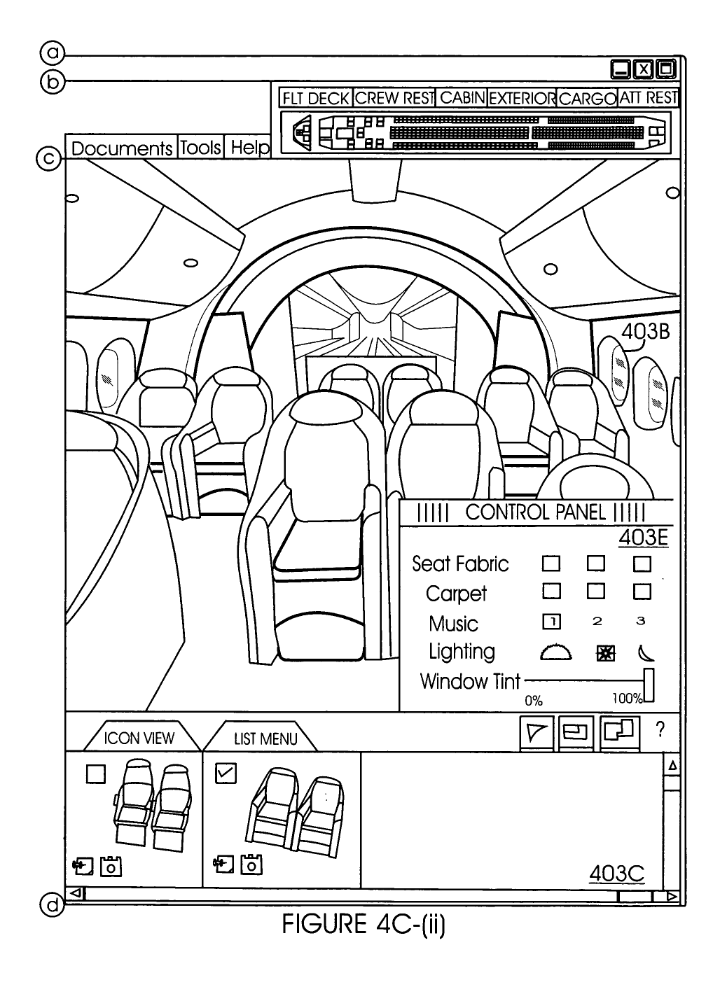

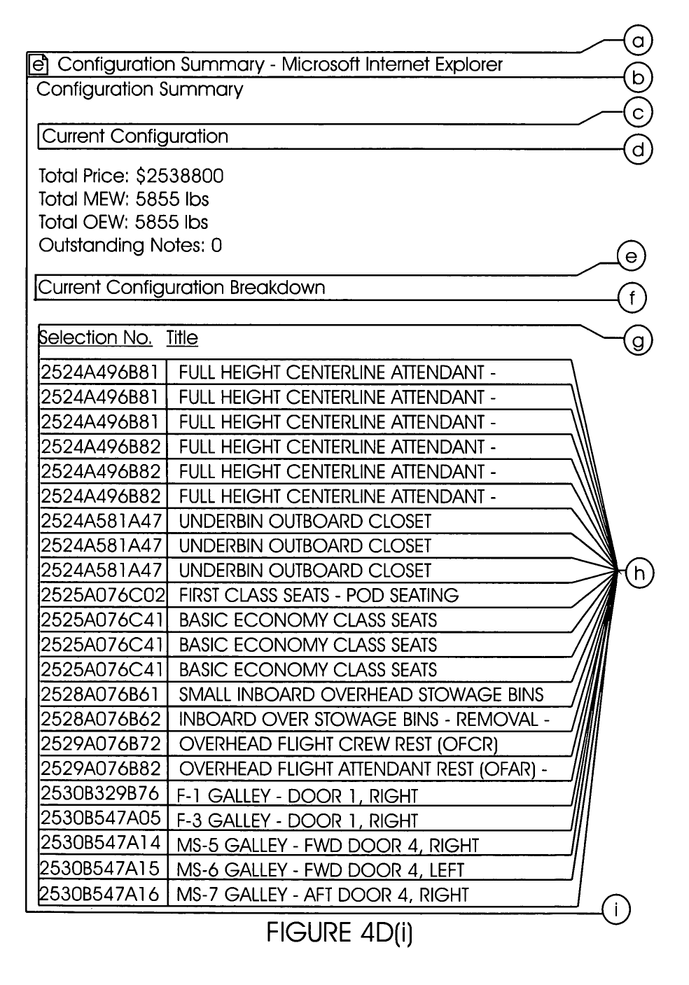

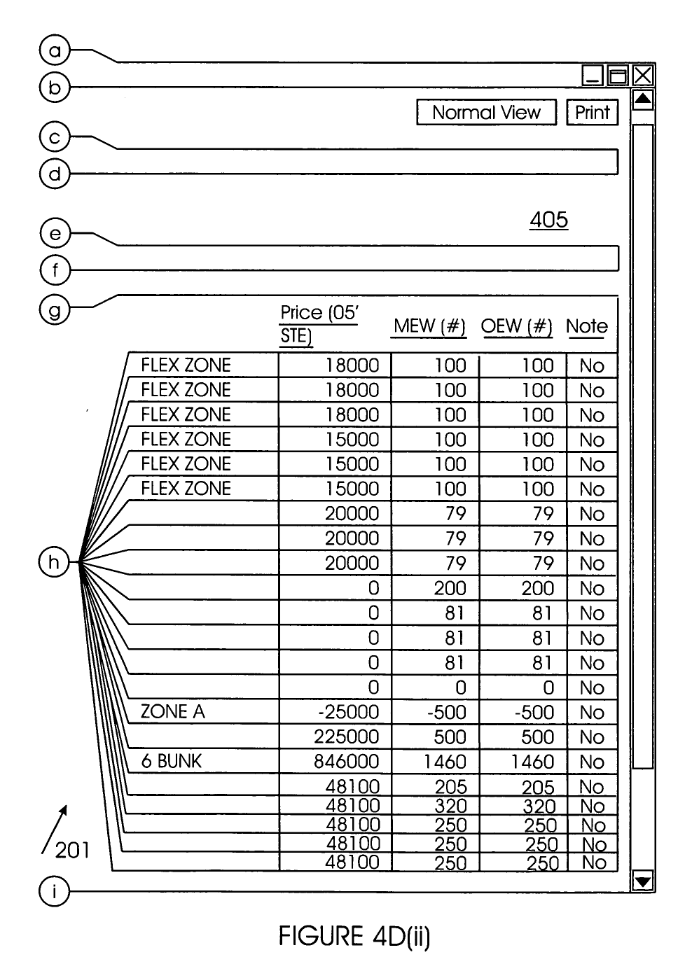

FIG. 2A shows a block diagram of a system 200 that provides an efficient and automated web-based configuration tool that is platform independent and easy to use. System 200 includes a user interface (“UI”) 201 (described below with respect to FIGS. 4A-4D) that allows a user to configure an aircraft. UI 201 interfaces with configuration application 202 that communicates with a user information and validation module 203, a view creation module 205 and a data collector 204.

User information and validation module 203 includes a security module that only allows authorized users to use interface 201 for configuring/re-configuring the aircraft. View creation module 205 provides the structure/view for interface 201. Data collector object 204 collects information from other modules, described below to build plural XML based objects.

XML communication layer 206 communicates with various databases through various interface layers. For example, an avionics database 213A communicates with XML communication layer 206 through a .COM layer 207 using visual basic (“VB”) rules. Database 212A and 212B communicate using a .NET interface 208 and a XML interface 209, respectively. .NET is an operating system provided by Microsoft Corp®. .NET uses HTTP, XML, SOAP and UDDI standards that are incorporated herein by reference. Database 212A provides all the basic configuration information for the LOPA view, described below. Database 212B provides different vendors to input information and the information is then sent to XML data communication layer 206 via XML interface 209.

An options database 211 (includes catalog options available to customers) interfaces with XML communication layer 206 via an Open Database Connectivity (“OBDC”) module 210. ODBC module 211 provides the various business rules for interface 201. The business rules provide the overall framework for selecting the options from options database 211.

Options database 211 also interfaces with a central database 213 (option data moving between 213 and 211 is shown as 215). New options are defined in the options database 211. Catalog data 214 is updated in XML database 216 and in central database 213 and is also made available to view creation module 205.

XML database 216 maintains plural XSLTs. This allows a user to access updated catalog data 214.

A user logs into system 200 using UI 201. The user configures the aircraft using UI 201 and configuration application 202. A LOPA view is created and various sub-systems are configured. The configuration is stored in configuration repository 217. Changes to the configuration are also tracked. The configuration information is stored in central database 213 and also published by publishing engine 218. Data may be published as electronic data 220 or as hard copy 219.

FIG. 2B shows a block diagram of the system that uses XML tags to identify various objects that are then used to configure an aircraft. XML tags 221 and 222 are used to identify 2D objects 223 and 3D objects 224, respectively. The information is assembled in a design system 225 that includes 2D and 3D systems for building the LOPA and other views that are described below. Design system 225 is similar to application 202 that communicates via XML data communication layer 206 with database 212A (and/or with 212B and 213). Configuration information is stored in central database 213 and is available to various departments, including a flight operation group 226, contracts group 227, manufacturing group 228 and any other group 229, including a user using interface 201.

Process Flow:

FIG. 3 shows a process flow diagram for configuring an aircraft's interior (or any other part) using the configuration tool (described above with respect to FIGS. 2A and 2B), according to one aspect of the present invention. Turning in detail to FIG. 3, in step S300, options database 211 is updated (or created). Options data 215 is also stored in central database 213.

Based on options data 215, in step S302, catalog data 214 is updated (or created) in XML database 216. In step S304, catalog data 214 is sent to configuration repository 217 via XML communication layer 206.

In step S306, options selection rules are defined by module 210. It is noteworthy that process steps S304 and S306 may occur simultaneously and may not be sequential.

In step S308, the user configures the aircraft using UI 201 based on configuration application 202. A LOPA is created and plural sub-systems are configured. Database for the LOPA is provided by database 212A.

In step S310, the configuration information is stored in configuration repository 217 and in step S312, the configuration information is published by publishing engine 218. It is noteworthy that during step S310, a previous configuration may be changed/updated.

Examples of User Interface 201:

FIGS. 4A-4D show plural screen shots of UI 201, according to one aspect of the present invention. As shown in FIG. 4A, UI 201 includes a LOPA design view tab 401, a catalog view tab 402, a 3D-view tab 403 and a configuration summary view tab 405. A user can easily switch between the views by clicking on a tab and all the views are linked with each other in real-time. Hence, all changes can be instantly viewed, accepted, rejected and/or reviewed. UI 201 also provides a running total of weights and costs as a user selects and/or de-selects options. It is noteworthy that any view may be removed, used with any other view or used exclusively based on a user's interface requirements/needs.

A LOPA view 404 shows the basic aircraft interior 404D. The user uses tagged SVG to layout the basic configuration 404D. Every part added or removed (404C) has an identifier tag to reflect the location of the part. Hence, by selecting the parts/options, a user instantly creates a XML document and the SVG LOPA is a graphical representation of the XML document with the tags. The user can utilize standard tools 404A to select/de-select components. Information about the parts is available using tab 404B. Once the overall LOPA is created, it is available instantly in catalog view and 3D view using tabs 402 and 403, respectively.

FIG. 4B shows a screen shot of a catalog-view that is accessible using tab 402. The catalog view displays a list of options shown in window 402E. A user can navigate through the list shown in windows 402E and select any item. The highlighted items (402A) are shown in windows 402B and 402C. Check boxes in windows 402B and 402C allow a user to select/de-select a particular option. When an option is elected, it changes the pricing and the weight, shown in section 402D of the screen shot. A user/administrator can add a text, video, photograph or any other media to an option to explain/clarify the option. By clicking on the next button 402F the user goes to the next folder on the list. A user can go to a detailed 3D view of any option by selecting 403.

In the 3D view, as shown in FIG. 4C, a user can virtually walk through an aircraft interior, flight deck, cargo compartments or exterior. The user can view the LOPA design, the selected option in the catalog view or any changes made from the summary view (for example, if an option is deleted). Window 403D shows a list of all the items that are available for 3D viewing. An item may be selected (for example, 403A) and viewed in window 403B.

Control panel 403E allows a user to change various interior elements, for example, the seat fabric, carpet colors, music, interior lighting and window dimming. List view 403C shows the selected options.

FIG. 4D shows an example of the overall summary of user selected options. Window 405 shows various options that are selected, the overall weight and the cost of the selected options. A user may click (select) an option from the summary view and then that will take the user to the catalog view allowing a user to select or deselect options. After selecting/deselecting an option, a user can see changes to the aircraft weight/costs instantly.

In one aspect of the present invention, an efficient and user-friendly interface is provided that allows a user to efficiently achieve a complex task of laying out an aircraft's interior. Although the example shows the interior, the same concept may be used for any part of the aircraft. Also, the interface is not limited to an aircraft, and may be used with other assemblies/products, for example, automobiles, trains, ships and other consumer/industrial products.

Those skilled in the art will appreciate that there are adaptations and modifications of the just-described preferred embodiments that can be configured without departing from the scope and spirit of the invention. Therefore, it is to be understood, that within the scope of the intended claims, the invention may be practiced other than is specifically described herein.

What is claimed is:

1. A graphical user interface (“GUI”) for product configuration, comprising:
a configuration interface that allows a user to build an overall product configuration;
a catalog interface that allows a user to select and/or de-select plural options;
a viewing interface that allows a user to view the overall product configuration and the plural options selected using the catalog interface; and
a summary interface that provides a summary of the plural options that are selected by the user.

2. The GUI of claim 1, wherein the catalog interface shows the change in product weight and cost when a user selects and/or de-selects an option.

3. The GUI of claim 1, wherein the viewing interface allows a user to view the product configuration with a selected option or a de-selected option.

4. The GUI of claim 1, wherein the GUI may be used to configure plural products including an aircraft.

5. A system for product configuration, comprising:
a user interface that allows a user to configure a product;
a web-based application that interfaces with the user interface, a data collector module and a view creation module allowing a user to configure the product; and
a data communication layer that interfaces between the web-based application and plural databases for building an XML based product configuration database.

6. The system of claim 5, wherein an options database is used to provide catalog data to a user for selecting and/or de-selecting options using the user interface.

7. The system of claim 5, wherein the data collector module interfaces with a configuration repository that stores a user selected configuration and is made available to plural business units.

8. The system of claim 5, wherein XML tags are used for identifying various options that are selected by the user.

9. The system of claim 5, wherein the system is used to configure plural products including an aircraft.

10. A method for product configuration, comprising:
creating and/or updating catalog data using XML tags;
allowing a user to select product configuration options; and
displaying user selected product options.

11. The method of claim 10, wherein product configuration options may be shared between plural business units.

12. The method of claim 10, wherein plural products, including an aircraft may be configured.

13. The method claim 10, further comprising:
displaying changes to product weight and/or cost when a user selects and/or de-selects an option.
